(19) United States
(12) Patent Application Publication
(10) Pub. No.: US 2008/0112874 A1
(43) Pub. Date: May 15, 2008

(54) METHOD FOR PRODUCING CALCIUM PHOSPHATE POWDERS USING AN AUTO-IGNITION COMBUSTION SYNTHESIS REACTION

(76) Inventors: Douglas E. Burkes, Idaho Falls, ID (US); John J. Moore, Evergreen, CO (US); Reed A. Ayers, Golden, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/848,520

(22) Filed: Aug. 31, 2007

Related U.S. Application Data
(60) Provisional application No. 60/824,114, filed on Aug. 31, 2006.

(51) Int. Cl. C01B 25/26; C01B 15/16

(52) U.S. Cl. 423/311; 977/900

(57) ABSTRACT

A method for making high purity, multiphasic calcium phosphate powders using an Auto-Ignition Combustion Synthesis (AICS) reaction of a calcium salt, a phosphate salt and a fuel is provided. In the method provided, energy released from the AICS reaction between the calcium salt, phosphate salt and fuel ignites at temperatures much lower than the actual phase transformation temperatures and reaches a high temperature rapidly enough for synthesis of the desired product to occur, without the requirement for coprecipitation, an external heat source for calcination and/or additional steps for removing undesired precursors from the desired final product.

### CROSS-REFERENCE TO RELATED APPLICATIONS

This application takes priority from U.S. provisional application 60/824,114, filed Aug. 31, 2006, which is hereby incorporated by reference herein.

### STATEMENT REGARDING FEDERALLY SPONSORED RESEARCH OR DEVELOPMENT

This invention was made with U.S. government support under Cooperative Agreement NCC8-238 awarded by NASA and the Center for Commercial Applications of Combustion in Space. The U.S. government has certain rights in the invention.

### BACKGROUND OF THE INVENTION

Calcium phosphate powders have been used extensively in different medical applications as biomaterials due to their excellent biocompatibility with human tissues. Calcium phosphate is a main constituent of bones and teeth of vertebrates. Calcium phosphate powders used in biomedical applications can vary in product stoichiometry, i.e. calcium to phosphorous ratio and crystal structure, depending on the desired use.

Calcium phosphate powders have previously been prepared using solid-state synthesis. In this method, fine powders of calcium and phosphorus oxides are mixed and calcined at elevated temperatures. Solid-state synthesis typically requires high temperatures, in excess of 1000° C., while full conversion is not guaranteed and a compositionally homogeneous product may be difficult to obtain. Solid-state reactions can produce multi-component oxides that require additional milling followed by a second calcination step in order to fabricate the desired oxide phase. In addition, powders produced using solid-state synthesis are often agglomerated and have irregular particle shape and size, thus resulting in poor sinterability.

Calcium phosphate powders have also been synthesized using wet chemical synthesis. Typical wet chemical synthesis can produce ceramic powders with high sinterability, high surface area, well-defined chemical compositions and homogeneous distribution of elements, but require expensive starting materials such as metal alkoxides and cryogenic agents and can only be used for small scale applications, such as those found in laboratories. In addition, hydrolysis of organometallic compounds, coprecipitation, and hydrothermal synthesis often complicate the fabrication procedure and present challenges for reproducibility.

Other fabrication processes used to produce calcium phosphate powder are hydrothermal reactions, microemulsion synthesis and mechanochemical synthesis. These synthesis methods lead to products having differences in morphology, crystal structure, stoichiometry and density.

Tas (Journal of the European Ceramic Society 20 (2000) 2389-2394) investigated producing calcium phosphate powders from calcium nitrate, dibasic ammonium phosphate and urea employing a “combustion reaction” in a simulated body fluid (SBF). Simulated body fluid simulates the ionic constituents of human plasma. It is well known that addition of calcium and phosphorous components to the SBF solution will initially precipitate calcium phosphate (i.e. coprecipitation), so that the ensuing combustion synthesis reaction serves only to sinter the precipitated calcium phosphate, not produce the compound directly. The calcium phosphate produced by Tas required a calcination process to obtain the desired product stoichiometry and crystallinity. In order for this to be accomplished, a constant external heat supply is required to maintain a high temperature (800° C. and above, depending on the desired phase) for an extended period of time (i.e. greater than one hour) for the appropriate phase transformation.

Han et al. (Materials Research Bulletin 39 (2004) 25-32) investigated producing calcium phosphate powders from a sol-gel formed from calcium nitrate, diammonium hydrogen phosphate (dibasic ammonium phosphate) and citric acid as the fuel employing a “combustion reaction.” These researchers observed only an amorphous XRD pattern after the initial combustion reaction. Crystalline calcium phosphate was not obtained until after a secondary calcination treatment at 750° C. In addition, due to the secondary calcination treatment, agglomeration of the calcium phosphate particles was observed and the particles had an effective diameter of 495 nm. The desired phase, hydroxyapatite (HA) in this case, was significantly altered by the high temperature calcination treatment, so that the final powder product was not the desired product due to decomposition of the HA. Decomposition of HA is undesirable due to poor mechanical properties and biological activity of the decomposition products including CaO. Employing this method, the researchers found that the hydrogen bond associated with their “combustion reaction” was not stable and broke down under the heating and/or humidity conditions, giving rise to serious agglomeration of the powders once calcined at the elevated temperature.

Varma et al. (Ceramics International 24 (1998) 467-470) investigated producing calcium phosphate powders via a polymeric combustion synthesis process involving calcium nitrate and triethyl phosphate. Similar to the other two researchers, the initial “combustion reaction” yielded no crystalline calcium phosphate compounds. Only after an additional calcination step at a minimum of 1000° C. were crystalline calcium phosphate compounds observed.

The current invention overcomes the aforementioned limitations of known processes by creating high purity multiphasic calcium phosphate powders in a single step without need for high temperature calcination and/or removing undesired precursor compounds from the product by washing.

### SUMMARY OF THE INVENTION

This invention provides a method for making high purity, multiphasic calcium phosphate powders using an Auto-Ignition Combustion Synthesis (AICS) reaction of a calcium salt, a phosphate salt and a fuel. Examples of the calcium salt include calcium nitrate (Ca(NO₃)₂.4H₂O), calcium chloride (CaCl₂), calcium iodide (CaI₂) and combinations thereof. Examples of the phosphate salt include monobasic or dibasic ammonium phosphate NH₄H₂PO₄ or (NH₄)₂HPO₄, respectively), monobasic or dibasic potassium phosphate (KH₂PO₄ or K₂HPO₄, respectively), monobasic aluminum phosphate (Al(H₂PO₄)₃), monobasic or dibasic sodium phosphate (NaH₂PO₄ or Na₂HPO₄, respectively) and combinations thereof. Examples of low-cost, readily available, easy to work with organic fuels include urea (CO(NH₂)₂), glycine (C₂H₅NO₂), N-methylurea (CH₃NHCONH₂), citric acid (HOC(COOH)(CH₂COOH)₂), stearic acid (CH₃(CH₂)₁₆COOH), ammonium bicarbonate (NH₄HCO₃), ammonium carbonate ((NH₄)₂CO₃) and combinations thereof. Other fuels, including other organic fuels may be used. Any combination of calcium salt(s), phosphate salt(s) and fuel(s) that produces the desired product(s) may be used. Combinations of both salt reactants and organic fuels can be used to tailor the reducing/oxidation power of the mixture and control off-gas concentrations (i.e. carbon, nitrogen, hydrogen, oxygen) that ultimately result in control of reaction temperature and time as well as product stoichiometry and particle morphology.

Combustion synthesis methods are generally described in Patil, Current Opinion in Solid State and Materials Science 6 (2002) 507-512.

In the method described here, energy released from the AICS reaction between the calcium salt, phosphate salt and fuel ignites at temperatures much lower than the actual phase transformation temperatures and reaches a high temperature rapidly enough for synthesis of the desired product to occur, without the requirement of a SBF or other substance for coprecipitation or an external heat source for calcination

The high purity multi-phasic powders produced by the methods described herein may consist of solely calcium phosphate constituents. Additional reaction components can be added to the reactant salt and fuel mixture thereby producing bioglass powders using the same fabrication process. The particular additional reaction components added and amounts added are known to one with ordinary skill in the art without undue experimentation.

Powders ranging in size from millimeters to nanometers can be produced by varying starting reactant stoichiometry and reactant to fuel mixture ratio, thereby controlling the maximum temperature observed during the AICS reaction. Generally, lower temperatures prevent the oxides from sintering, thereby requiring additional calcination processes. Lower temperatures are achieved by lower than or significantly higher than stoichiometric fuel contents in the mixture, lower ambient temperatures resulting in prolonged duration of decomposition of the starting reactants, along with slower heating rates or addition of diluents that serve as a heat sink, absorbing energy from the reaction system. Conversely, higher temperatures promote sintering of the oxides but can result in a loss of sub-micron features and produce a less crystalline phase of the product powder. Higher temperatures are achieved by fuel contents closer to the stoichiometric value of the mixture, higher ambient temperatures and heating rates that increase the rate of reactant decomposition and reaction vessel ambient temperature (pre-heat), as well as ensuring full conversion of the reactants to the desired products by careful selection of starting mixture stoichiometry. These are extremely important processing parameters for calcium phosphate fabrication and are often overlooked by similar fabrication processes.

Auto-Ignition Combustion Synthesis (AICS) overcomes the limitations and deficiencies of other oxide powder fabrication processes by eliminating a decomposition and/or calcination step. The AICS method takes advantage of an exothermic, i.e. heat generating, chemical reaction that is rapid and self-sustaining, meaning that the heat generated by the exothermic chemical reaction is sufficient to drive the reaction itself so that an external heat source is not required. This invention takes advantage of redox (reduction-oxidation) mixtures of water soluble calcium and phosphate salts with a suitable organic fuel. In short, the AICS fabrication process brings a saturated or unsaturated aqueous solution of the desired reactant salts and organic fuel to a boil until the mixture ignites spontaneously followed by a swift and self-sustaining combustion reaction that results in a powder having desired stoichiometry(ies).

As mentioned above, the mixture can be either in a saturated or unsaturated state. Ultimately during initial heating, structural water contained within the reactant salt will be released and decomposition of the organic fuel forms water resulting in a semi-saturated solution. Addition of water to the initial heating step serves as a buffer solution to aid in dissolving the granular reactants. Whether additional water is provided or not, the reaction will proceed, although homogeneity and uniform distribution of the desired products may not be optimum without use of an additional buffer. Other constituents, such as alcohols, ketones, etc., may be used as buffer solutions that contribute additional controls over the process and product, as long as the selected solvent is compatible with the initial reactants and does in fact result in dissolution and complete decomposition. The composition of other constituents that can act as buffer solutions are easily determined by one of ordinary skill in the art without undue experimentation.

As used herein, “organic” means carbon-containing. In one embodiment, the carbon-containing fuel contains elements other than carbon, and is not solely carbon-containing. Examples of materials which are solely carbon-containing include carbon black, graphite, activated carbon, soot or petroleum coke.

In the invention described herein, the aqueous reaction mixture is self-ignited and propagated when heated. The method described herein does not require a calcination step to produce the desired calcium phosphate powder.

In one embodiment, dopants and/or diluents may be added to the reaction mixture, provided that the dopant and/or diluent do not prevent the formation of the desired product. Suitable dopants and/or diluents include silica, sodium oxide, sodium nitrate, potassium nitrate, magnesia, titania, alumina and zirconia. Such dopants will aid in the formation of bioglasses, unless completely decomposed and off-gassed, in which case the dopant will serve as a diluent, i.e. a heat sink that removes energy from the reaction system.

After the powders are prepared using the methods described herein, the powder can be formed into a desired shape using methods known in the art without undue experimentation.

As used herein, “high purity” materials are materials which contain less than or equal to 0.1% of elements that are not part of the desired product. These impurities are typically carbon or carbon-containing species (outside of any desired carbon-containing species).

As used herein, “multiphasic” is used to indicate the material contains more than one phase of calcium phosphate. Some phases of calcium phosphate are tri-calcium phosphate (Ca₃(PO₄)₂) (alpha, beta or gamma), di-calcium phosphate (CaHPO₄ (brushite or monetite) or Ca₂P₂O₇ pyrophosphate (alpha, beta, gamma or dehydrate)), tetra-calcium phosphate (Ca₄O(PO₄)₂), hydroxyapatite (Ca₁₀(PO₄)₆(OH)₂), octacalcium phosphate (Ca₈H₂(PO₄)₆.5H₂O), heptacalcium phosphate (Ca₇(P₅O₁₆)₂), calcium phosphate monohydrate (Ca(H₂PO₄)₂.H₂O), hydroxy carbonate apatite (similar to hydroxyapatite but containing small amounts of CO₂) and mixtures thereof. Monophasic materials can be produced by altering the starting reactant materials/fuels and process parameters as described herein and known to one of ordinary skill in the art without undue experimentation. As used herein, “bioglass” is used to indicate an amorphous material, i.e. a solid material with enormous structural disorder or a liquid with a very high viscosity, of the same product stoichiometry as that referred to as the ceramic (whether high or low percentage of crystallinity).

As used herein, “ignition temperature” means a temperature where the reaction mixture spontaneously ignites. This temperature is typically the lowest temperature at which one of the reactants decomposes. The reaction mixture may be maintained at the ignition temperature for some time before ignition occurs. Suitable ignition temperatures depend on the composition of the reactants, and are easily determined by one of ordinary skill in the art without undue experimentation.

As used herein, “powder” means a material in a solid form able to be readily mixed with an additional carrier (such as polymethylmethacrylate (PMMA)) or able to be readily pressed into a desired shape. Powder is understood to be different than pieces or bulk structures of product. Powder can be further milled to a desired size, if need be, but is not necessarily required in the sense of the word used herein. Powder offers advantages over other material forms (i.e. pieces, structures, etc.) in the fact that powders are able to adapt to a specific profile or shape.

The reaction described herein can be used to prepare various particle sizes, such as micrometer to nanometer particle diameters. The particle size can be tailored to match a desired size, such as for a customer requirement using the methods described herein and known to one of ordinary skill in the art without undue experimentation. In one embodiment, the product comprises an average particle size between about 1 nm to about 1 mm, and all intermediate values and ranges therein. In one embodiment, the product comprises an average particle size between about 1 nm to about 800 micron, and all intermediate values and ranges therein. In one embodiment, the particle size produced is less than about 495 nm. In one embodiment, the particle size produced is less than about 900 nm. In one embodiment, larger particle sizes are the result of agglomeration of smaller particles, as known in the art. These various particle sizes can be tailored by varying the starting reactant stoichiometry and reactant-to-fuel mixture ratio, which control the maximum temperature in the reaction. In one embodiment, the particles formed are uniformly sized, i.e., having about 90% of the particles having diameter within 10% of each other. In one embodiment, the particles formed have about 90% of the particles having diameter within 5% of each other.

### BRIEF DESCRIPTION OF THE DRAWINGS

FIG. 1 shows maximum reaction temperature as a function of urea fuel (x) content.

FIG. 2 shows time-temperature profiles as measured by a Type K thermocouple placed directly above reaction vessel as a function of urea fuel (x) content.

FIG. 3 shows simultaneous thermal analysis (STA−combined differential scanning calorimetry (DSC) and thermogravimetric analysis (TGA)) profiles of the (a.) urea, (b.) dibasic ammonium phosphate and (c.) calcium nitrate reactants.

FIG. 4 shows X-ray diffraction patterns of multiphasic calcium phosphate powders produced as a function of fuel content (n). n=3 is the stoichiometric fuel content.

FIG. 5 shows resultant product average particle diameter as a function of fuel content (x).

FIG. 6 shows X-ray diffraction patterns of multiphasic calcium phosphate powders produced as a function of calcium (C) to phosphorous (P) ratio.

FIG. 7 shows resultant product average particle diameter as a function of calcium (C) to phosphorous (P) ratio.

FIG. 8 shows a SEM photomicrograph of an AICS product with urea fuel (n) content equal to 3 (stoichiometric) and a C:P ratio of 1.5. The photomicrograph reveals very small particles that are agglomerated (sintered) in nature producing an overall ‘powder’ size no greater than 200 μm.

FIG. 9 shows a SEM photomicrograph of an AICS product with urea fuel (n) content equal to 4.5 and a C:P ratio or 1.3. The photomicrograph reveals smaller particles than those in FIG. 8, that are still agglomerated in nature, although to a lesser degree than observed in FIG. 8.

### DETAILED DESCRIPTION OF THE INVENTION

As is known in the art, it is understood that the same crystal structures and compositions can be named differently and can be represented differently in a formula by those of ordinary skill in the art. Therefore, when a composition is named or a formula shown in the disclosure herein, all equivalent names or formulas are intended to be included.

This invention is useful in many different fields including the biomedical area, for example as bone cement or a drug delivery system. This invention is also useful to prepare precursors for catalytic supports and microfilter applications.

The process described herein provides a method to produce a product with the desired stoichiometry by mixing the calcium salt, phosphate salt and organic fuel in the appropriate calcium to phosphorous ratio and fuel to oxidizer ratio.

The examples described herein are intended to be exemplary and non-limiting and are intended to aid in the understanding of the invention. In one embodiment, the reactants are mixed in a suitable combustible container, such as a Pyrex beaker, with distilled water in open air. In one embodiment, the distilled water ratio is maintained at 1 mL per 1 g of reactant mixture, i.e. 10 g reactant mixture requires 10 mL distilled water to serve as a buffer to aid in dissolution of the initial reactants. This ratio may change, as long as the reaction proceeds to the desired extent. The mixture is pre-heated on a hot plate to release structural water in the reactants and drive moisture from the mixture for ten minutes resulting in a viscous, white paste. The paste is inserted into a pre-heated furnace with a suitable temperature. In one embodiment, the temperature is 500±20° C., where ignition of the mixture takes place after about four to six minutes, depending on initial reactant stoichiometry. Increasing the temperature can aid in reducing water content and carbon containing species in the final product, as can quenching the product after ignition. Combustion of the mixture is typically in the form of a bright yellow-orange incandescent flame and typically lasts less than one minute accompanied by a significant amount of gas generation. In one example, the AICS process lasts less than 20 minutes from initial mixing to extinction of the combustion wave—this equates to a great deal of energy and time savings as well as allowing a high product throughput.

Non-limiting examples are described below. All experiments were performed in open air using calcium nitrate, dibasic ammonium phosphate and urea as the fuel, although other starting materials such as monobasic ammonium phosphate and other fuels, such as methylurea, citric acid and glycine, can be used as starting reactant materials.

In these examples, two variables were investigated, product as a function of fuel content assuming theoretical formation of tri-calcium phosphate (C/P=1.5) and product as a function of calcium to phosphorous ratio (C/P) holding urea fuel content constant at 5 moles.

The following equations are exemplary and describe the examples performed here:

3Ca(NO₃)₂.4H₂O₍ₛ₎+2(NH₄)₂HPO₄₍ₛ₎+xCO(NH₂)₂₍ₛ₎=Ca₃(PO₄)₂₍ₛ₎+(21+2x)H₂O_{(g)}+xCO_{2(g)}+(5+x)N_{2(g)}+(4.5−1.5x)O_{2(g)} Equation (1)

3Ca(NO₃)₂.4H₂O₍ₛ₎+y(NH₄)₂HPO₄₍ₛ₎+5CO(NH₂)₂₍ₛ₎=Ca₃P_{y}O_{(3+2.5y)(s)}+(22+4.5y)H₂O_{(g)}+5CO_{2(g)}+(8+y)N_{2(g)}−0.25yO_{2(g)} Equation (2)

For Equations 1 and 2, (s) subscript represents solid form while (g) subscript represents gaseous form. In Equation 1, x (urea fuel) was varied in moles as provided on the figures. In Equation 2, y (phosphorous content) was varied in moles to produce desired C/P ratios of 1.3, 1.4, 1.5, 1.6 and 1.7 as provided on the figures.

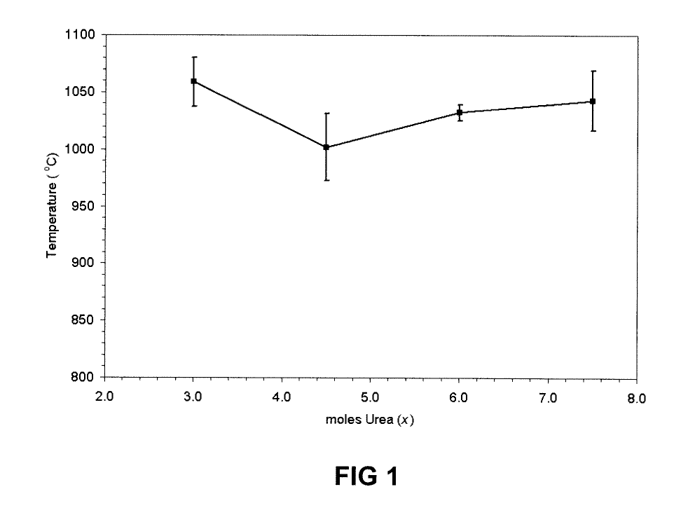

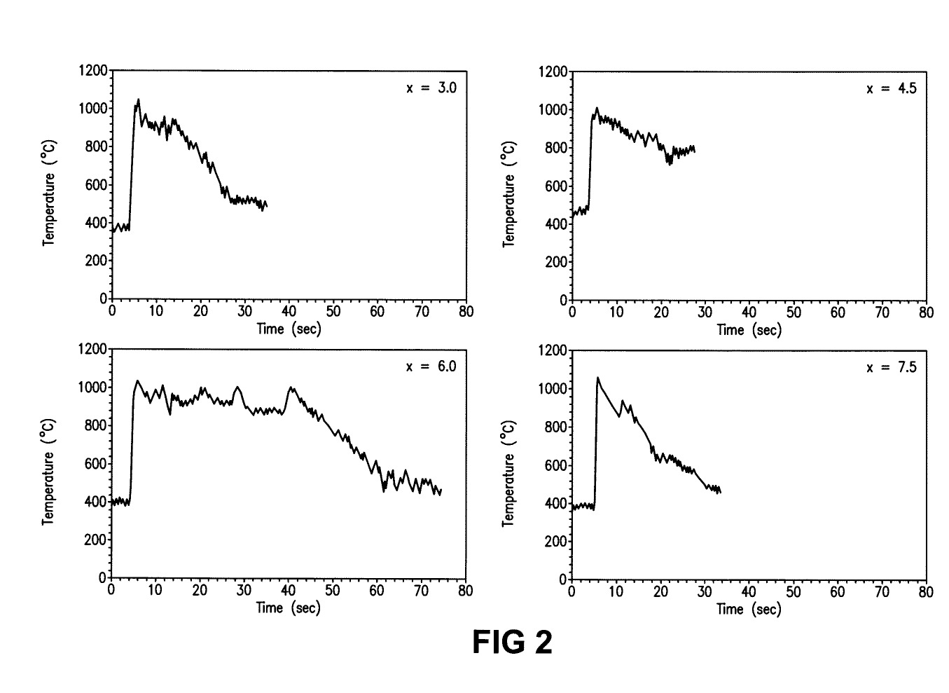

Control of the fuel:salt ratio and/or the C:P ratio can result in higher or lower reaction temperatures for varying amounts of time. Results as a function of urea fuel content (x) are provided in FIG. 1 with x=3 (stoichiometric), 4.5, 6 and 7.5 moles. In addition, time-temperature profiles as a function of urea fuel content (x) as measured by a type K (Chromel-Alumel) thermocouple placed directly above the reaction vessel are provided in FIG. 2. Observation of these figures reveals that the highest reaction temperature occurs for the stoichiometric fuel content, i.e. x=3, as expected since this amount of fuel provides the maximum reducing power in the mixture. As fuel amount is continually increased, the maximum temperature rapidly decreases followed by a steady increase up to x=7.5. In addition, the stoichiometric fuel content provides rapid heating and cooling rates. As the fuel content is increased the heating rate is prolonged accompanied by much slower cooling rates until x=6 whereby the heating and cooling rates begin to increase once again. These variations in maximum reaction temperature but also heating and cooling rates will affect the product particle morphology and amount of agglomeration, i.e. large granular particles or small, uniform spherical particles, as well as the microstructural characteristics, i.e. mainly crystalline, mainly amorphous or a mixture of both.

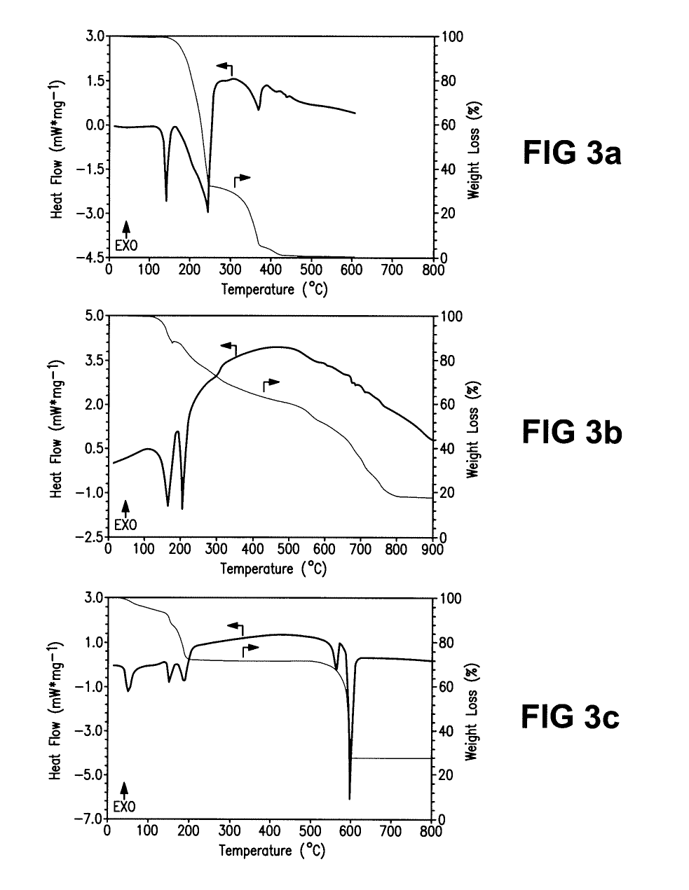

Examples of simultaneous thermal analysis (STA) profiles for calcium nitrate, dibasic ammonium phosphate and urea are provided in FIG. 3. Observation of the STA profiles reveals that, for these components, ignition must occur above 200° C., since this is the minimum decomposition temperature (outside of structural water release and boiling), occurring for dibasic ammonium phosphate, of the three reactants. In addition, the maximum reaction temperature must exceed 600° C. for these components since this is the final decomposition stage for calcium nitrate. Thus, the organic fuel will decompose completely leaving no residue in the final product and serving as the auto-ignition source, while calcium nitrate decomposes to calcium oxide and dibasic ammonium phosphate decomposes to phosphorous pentoxide. Once ignition of the urea compound occurs, an exothermic reaction is initiated between the two oxide compounds resulting in the desired product phase(s).

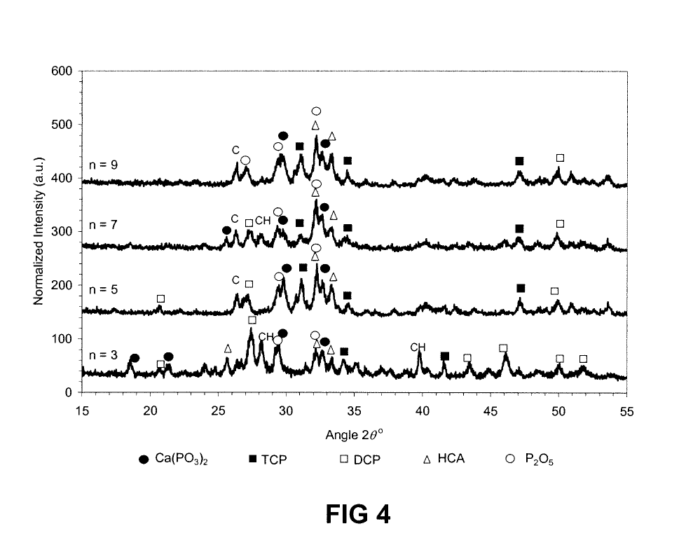

FIG. 4 shows X-ray diffraction results for the experiment described in Equation (1). Here, TCP (filled square) represents tri-calcium phosphate, DCP (open square) represents di-calcium phosphate, HCA (open triangle) represents hydroxyl-carbonate-apatite, P₂O₅ (open circle) represents phosphorous pentoxide (unreacted phosphorous component), C represents calcium oxide (unreacted calcium component) and CH represents calcium hydrogen. This figure reveals that despite the short reaction time, AICS of calcium nitrate and dibasic ammonium phosphate using urea as a fuel produced crystallized, multi-phasic calcium phosphate powders. Increasing fuel content while holding calcium to phosphorous ratio constant at 1.5 yielded more unreacted components, more carbonate apatite and more tri- and di-calcium phosphate components. The increase in unreacted components and carbonate apatite is the result of decreased reaction temperatures with increased fuel content and more carbon available to form carbonates. An increase in reaction temperature with less carbonate apatite formation could be obtained by selecting an alternative organic fuel or a mixture of fuels with a greater reducing power, i.e. citric acid, methylurea, glycine, etc.

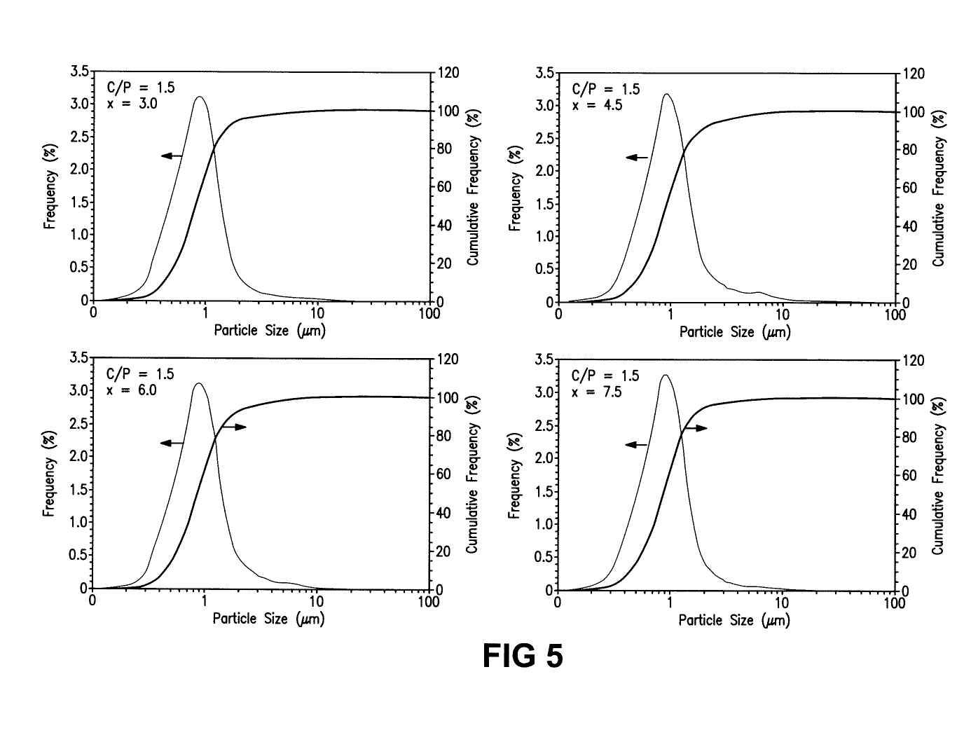

FIG. 5 shows average particle diameter as a function of fuel content. As observed in the figure, the particle size ranges from 129 nm to 111 μm, with the greatest percentage of particles being 866 nm in diameter. Generally, higher temperatures lead to an increase in fine particles and an increased size distribution as a result of increased agglomeration of the finer particles. Lower temperatures, i.e. greater than stoichiometric fuel amounts, typically produce slightly more coarse particles, but with a much more narrow size distribution as a result of less agglomeration and slower cooling rate.

Using the information provided here, along with the information known to one of ordinary skill in the art, the desired particle size and particle distribution can be produced.

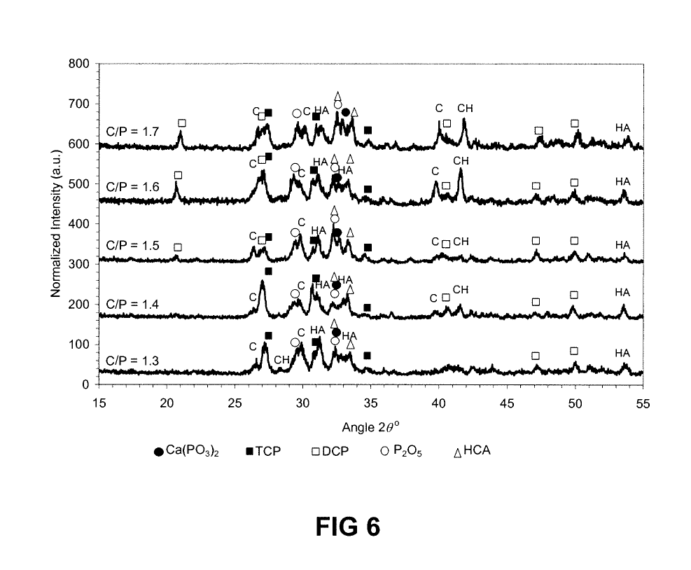

FIG. 6 shows X-ray diffraction results for the experiment described in Equation (2). Here, TCP (filled square) represents tri-calcium phosphate, DCP (open square) represents di-calcium phosphate, HCA (open triangle) represents hydroxyl-carbonate-apatite, P₂O₅ (open circle) represents phosphorous pentoxide (unreacted phosphorous component), C represents calcium oxide (unreacted calcium component) and CH represents calcium hydrogen. This figure also revealed that despite the short reaction time, AICS of calcium nitrate and dibasic ammonium phosphate using urea as a fuel produces crystallized, multi-phasic calcium phosphate powders. Increasing the C/P ratio while holding the fuel content constant at 5 moles yielded more unreacted components, less hydroxyl apatite and more tri- and di-calcium phosphate components. The increase in unreacted components, particularly CaO, is the result of increased calcium nitrate and decreased di-basic ammonium phosphate in the reactant mixture to increase the C/P ratio. Less hydroxyl apatite formation is the result of increased combustion temperatures with increased C/P ratio, even though fuel content is only slightly raised with increased C/P ratio. Higher combustion temperatures drive more water off of the mixture, leaving less available to form a hydroxyl apatite.

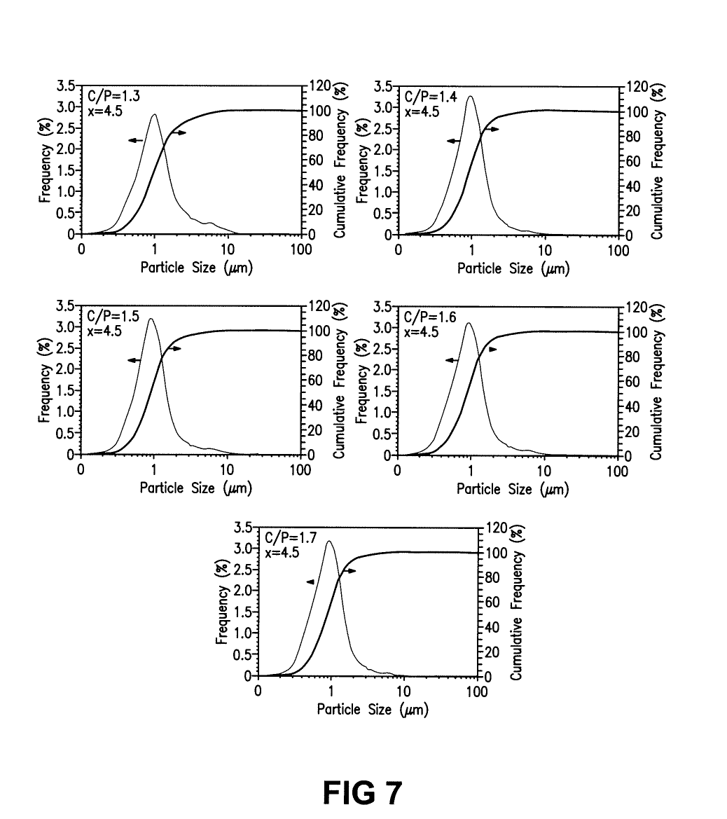

FIG. 7 shows average particle diameter as a function of calcium (C) to phosphorous (P) ratio. As observed in the figure, the particle size ranges from 129 nm to 50.5 μm, with the greatest percentage of particles being from 866 to 965 nm in diameter. C:P ratio has a more significant impact on particle size and distribution with a constant amount of fuel, 4.5 moles of urea in this case, than does the fuel alone with a constant C:P ratio. Thus, desired particle size and stoichiometry must be carefully considered in terms of C:P atomic ratio and fuel content.

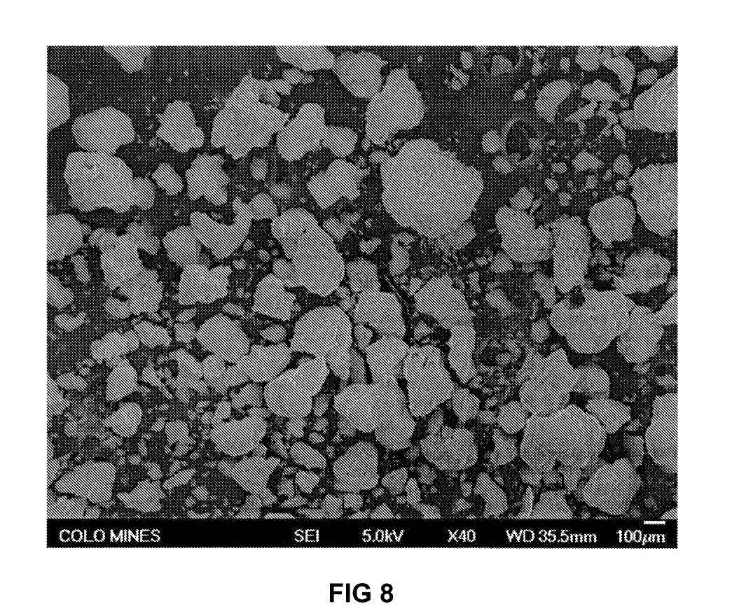

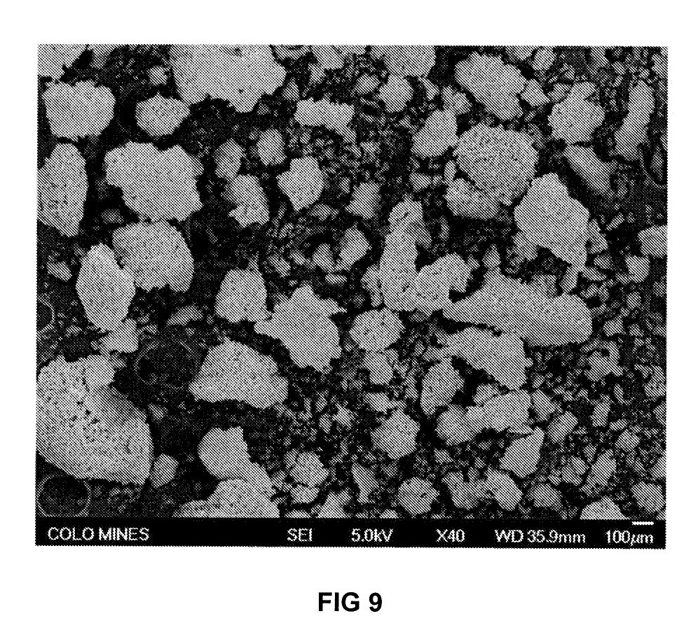

A SEM photomicrograph of a sample AICS product with urea fuel content (x) equal to 3 and a C:P ratio equal to 1.5 is provided in FIG. 8. Observation of FIG. 8 shows that sintering of the very fine product particles has occurred as a result of the high reaction temperature and rapid heating and cooling rates (refer to temperature profiles provided above). This observation was also confirmed by the particle size analysis. While coarser agglomerates are observed, fine, less agglomerated particles can also be observed in the photomicrograph. A SEM photomicrograph of a sample AICS product with urea fuel content (x) equal to 4.5 and a C:P ratio equal to 1.3 is provided in FIG. 9. Observation of this photomicrograph shows that particles are still very fine in nature along with significantly less agglomeration than that observed in FIG. 8. An increased amount of finer particles can be observed in the figure. These observations also confirm the particle size analysis that C:P ratio has a more significant impact on particle size and distribution than does fuel content alone. In general, lower temperatures and/or slower heating and cooling rates will result in less agglomerated (sintered) particles that are less crystalline in nature and contain more amorphous phases. This is accomplished by adjusting the fuel ratio to 6. Beyond this fuel content, temperatures and heating/cooling rates increase once again, so that further tailoring of particle characteristics is accomplished by changing or substituting the urea fuel (used in the examples provided) with another organic fuel, such as glycine. Glycine has been shown to form nanosize particles with significantly increased surface areas while exhibiting a non-flaming linear combustion reaction for compounds prepared by a similar processing route (Patil, Current Opinion in Solid State and Materials Science 6 (2002) 507-512). Furthermore, modification of the C:P ratio can be employed to control temperature and heating/cooling rate, but careful consideration must be given to the desired product phase(s), since C:P is a dominant factor for control of stoichiometry. These modifications, including the C:P ratio, are easily carried out by one of ordinary skill in the art without undue experimentation, using the information provided here.

When a group of substituents is disclosed herein, it is understood that all individual members of those groups and all subgroups, including any isomers and enantiomers of the group members, and classes of compounds that can be formed using the substituents are disclosed separately. When a compound or method is claimed, it should be understood that compounds or methods known in the art including the compounds or methods disclosed with an enabling disclosure in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomer and enantiomer of the compound described individual or in any combination. One of ordinary skill in the art will appreciate that methods, steps, and starting materials other than those specifically exemplified can be employed in the practice of the invention without resort to undue experimentation. All art-known functional equivalents of any such methods steps and starting materials are intended to be included in this invention. Whenever a range is given in the specification, for example, a temperature range, a time range, a particle size range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

In general the terms and phrases used herein have their art-recognized meaning, which can be found by reference to standard texts, journal references and contexts known to those skilled in the art. The definitions are provided to clarify their specific use in the context of the invention.

All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The compounds used, products formed and methods and accessory methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Although the description herein contains many specificities, these should not be construed as limiting the scope of the invention, but as merely providing illustrations of some of the embodiments of the invention. Thus, additional embodiments are within the scope of the invention and within the following claims. All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention.

We claim:

1. A method for preparing multiphasic calcium phosphate powders comprising heating an aqueous reactant mixture comprising a calcium salt, a phosphate salt and an organic fuel to an ignition temperature.

2. The method of claim 1, wherein the ratio of calcium/phosphate is between 0.5 to 5.

3. The method of claim 2, wherein the ratio of calcium/phosphate is between 1 to 2.

4. The method of claim 1, wherein the fuel content is stoichiometric.

5. The method of claim 1, wherein the fuel content is up to three times greater than the stoichiometric ratio.

6. The method of claim 1, wherein the ignition temperature is below the phase transformation temperature of the desired phase.

7. The method of claim 1, wherein the powder has purity of greater than or equal to 99.9%.

8. The method of claim 1, wherein the particle size is between 1 nm and 1 mm.

9. The method of claim 1, wherein the particle size is between 1 nm and 900 microns.

10. The method of claim 9, wherein the particle size is between 1 nm and 500 nm.

11. The method of claim 9, wherein the particle size is between 50 nm and 250 nm.

12. The method of claim 1, wherein the fuel is selected from the group consisting of glycine, urea, methylurea citric acid, stearic acid, ammonium bicarbonate and ammonium carbonate, and mixtures thereof.

13. The method of claim 1, wherein the calcium salt is selected from the group consisting of: calcium nitrate, calcium chloride and calcium iodide, and mixtures thereof.

14. The method of claim 1, wherein the phosphate salt is selected from the group consisting of: monobasic ammonium phosphate, dibasic ammonium phosphate, monobasic potassium phosphate, dibasic potassium phosphate, monobasic aluminum phosphate, monobasic sodium phosphate, and dibasic sodium phosphate, and mixtures thereof.

15. The method of claim 1, further comprising adding one or more members of the group consisting of: silica, sodium oxide, sodium nitrate, potassium nitrate, magnesia, titania, alumina and zirconia.

16. The method of claim 1, wherein 90% of the particles have a diameter within 10% of each other.

17. A multiphasic calcium phosphate powder made by the method of claim 1.

18. A high purity multiphasic calcium phosphate powder made by the method of claim 1.

19. A multiphasic calcium phosphate powder ranging between 0 and 50% tricalcium phosphate, between 0 and 50% dicalcium phosphate, between 0 and 50% hydroxy-carbonate-apatite, and between 0 and 50% hydroxy-apatite, so that the total sum of multiphasic calcium phosphate powder is 100%.
